(19) United States
(12) Patent Application Publication
(10) Pub. No.: US 2003/0177155 A1
(43) Pub. Date: Sep. 18, 2003

(54) Random number converter of distribution from uniform to gaussian-like

(76) Inventor: J. Barry Shackleford, Portola Valley, CA (US)

Correspondence Address: HEWLETT-PACKARD COMPANY, Intellectual Property Administration, P.O. Box 272400, Fort Collins, CO, 80527-2400, US

(21) Appl. No.: 10/097,957

(22) Filed: Mar. 15, 2002

(51) Int. Cl. G06F 1/02

(52) U.S. Cl. 708/250

(57) ABSTRACT

A cellular array for generating a stream of random numbers in a Gaussian distribution from a stream of random numbers in a uniform distribution includes identical, repeating cells that receive one bit as input, store the bit, add the bit to a previously stored bit, and produce one sum bit as output. The cellular array is a hardware-based, flexible array that is advantageous to integrated circuit implementation, in that all of the connections are local, and also rapidly producing a stream of random numbers in a Gaussian distribution.

### TECHNICAL FIELD OF THE INVENTION

This invention relates generally to the field of random number generation, and more specifically to a method of generating random numbers in a Gaussian or bell curve distribution through a hardware design optimally configured for implementation on integrated circuits.

### BACKGROUND

Noise generators are frequently utilized in testing communications and other electronic equipment. The most common type of noise source is an analog device which relies upon a thermal noise diode to generate Gaussian noise.

Commercial noise sources depend on the statistics of electron flow across PN junctions to generate noise which has a Gaussian amplitude distribution and a flat frequency spectrum. Generally, the noise power level is known only approximately and it will vary with time and the ambient temperature. The testing of electronic equipment at high bit rates typically requires a wide band noise source. For some testing applications, e.g., to match a lower data rate, the noise can be filtered to reduce its bandwidth. However, this results in a concomitant reduction in the amplitude of the noise, thereby requiring amplification to restore the noise to its original level. Thus, for some testing applications a number of analog noise generators, each providing a different bandwidth, are utilized to cover the desired bit rate range. However, such an approach is not without some drawbacks, e.g., precise amplification of the various generators must be achieved.

The generation of noise via the use of a digital source has been proposed as an alternative to analog noise generation. In this connection pseudorandom binary sequence generators, e.g., shift registers, have also been used as noise sources in commercial instruments. Typically, analog noise is generated from the binary output of such registers by severely limiting its bandwidth with an analog low-pass filter.

Another approach to the synthesis of noise via digital techniques is to utilize a digital filter to generate a Gaussian amplitude distribution, but with the same (sine x)/x bandwidth distribution as the input sequence. However, this approach does not meet the requirement for a flat noise spectrum.

Still another approach to digital synthesis of noise has been proposed. That approach utilizes plural digitally generated noise samples for generating an analog output by means of a digital-to-analog converter. However, with such an approach, if processing is done in real time, the noise bandwidth is limited by the processor speed. If random-stored values are used, the requirement for some values to occur with low probability makes the memory size prohibitive.

Rather than addressing these concerns, the generation of random number streams in a Gaussian distribution is currently performed using software methods. Software implementations of Gaussian distribution random number generators are application-specific and, due to their inefficient utilization of logic gates, do not effectively translate to integrated circuits. A better and more hardware-based approach to digital noise synthesis is, therefore, needed.

### SUMMARY

The present invention is a circuit and method for converting a stream of uniformly distributed random numbers to a stream of random numbers with an approximately Gaussian or bell curve distribution. The input is a stream of random numbers with a uniform distribution of values between a given range of numbers and output is a stream of random numbers with an approximately Gaussian or bell curve distribution of values between another given range of numbers. Using an iterative array of cells, one random number of the incoming stream of random numbers is summed with a time-delayed copy of a previous incoming number, and the sum of the two numbers will be the output of the converter. The array may be designed to use one or more stages or rows of the array. The sum of the converter is double the value of the input for each stage or row of the array. Increasing the number of stages increases the range of the output and also the steepness of the Gaussian distribution of the output. Because each cell used in the array has a combination of single-bit registers and a full adder, the cellular array is advantageous to integrated circuit implementation and operates at a rapid speed of one random number per clock cycle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DESCRIPTION OF THE DRAWINGS

The features, aspects, and advantages of the present invention will become better understood with regard to the following description, appended claims, and accompanying drawings where:

FIG. 1 depicts a circuit diagram of a single cell according to an embodiment of the present invention;

FIG. 2 depicts a high-level diagram of the single cell of FIG. 1;

FIG. 3 depicts a sample configuration of a cellular array using the single cell of FIG. 1;

FIG. 4 depicts a cell of an alternate embodiment of the present invention;

FIG. 5 depicts a cell of another alternate embodiment of the present invention;

FIG. 6 depicts a cell of yet another alternate embodiment of the present invention;

FIG. 7 depicts a cellular array of an alternate embodiment of the present invention;

FIG. 8A depicts an input data stream into the cellular array of FIG. 7;

FIG. 8B depicts the data stream after having passed through one stage of the cellular array;

FIG. 8C depicts the data stream after having passed through two stages of the cellular array;

FIG. 8D depicts the data stream after having passed through three stages of the cellular array; and

FIG. 8E depicts the data stream after having passed through four stages of the cellular array of FIG. 7.

### DETAILED DESCRIPTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the spirit and scope of the invention. The present invention is not intended to be limited to the embodiments shown, but is to be accorded the widest possible scope consistent with the principles and features disclosed herein.

A currently preferred method to convert random numbers with a uniform distribution to a Gaussian-like distribution of random numbers is to repeatedly sum numbers. Given two 8-bit random numbers in the range [0 . . . 255], each has an equal probability of being any number in the given range. If the two numbers are added, the sum will be in the range [0 . . . 510]. It should, of course, be understood that there is only one way to produce the numbers at the extreme ends of the distribution of 0 and 510, i.e., both 8-bit random numbers must be equal. Likewise, there are only two ways to produce a sum of 1 or 509, three ways to produce a sum of either 2 or 508, and so on. Thus, as the sum gets greater up to the midpoint of the range, the probability of occurrence increases. Likewise, as the sum gets greater past the midpoint of its range, the probability of occurrence then decreases. The probability of any number occurring has been converted from an equal chance of any number occurring to a more complicated probability, with each number in the given range having a specific probability of occurring. Thus, the sums of the incoming random numbers are no longer a uniform distribution but rather a more triangular one. When two sums are added, then the distribution approaches Gaussian, and becomes closer to ideal with each further iteration. It should be apparent to those skilled in the art that an ideal Gaussian distribution can never be obtained in a digital system, as a mathematically ideal model contains an infinite amount of very-low-probability numbers that can not be duplicated in a real-world, digital scheme.

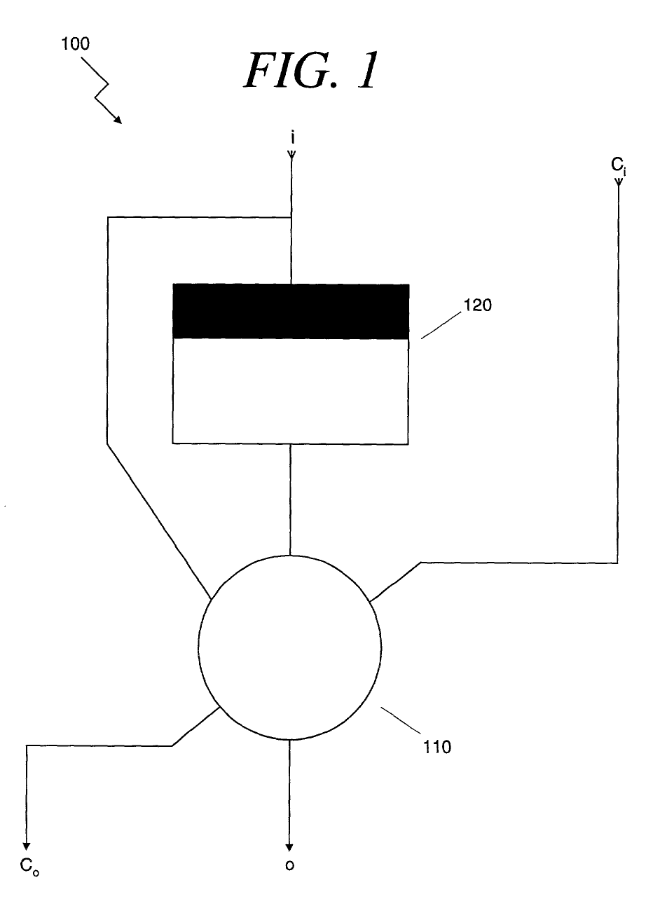

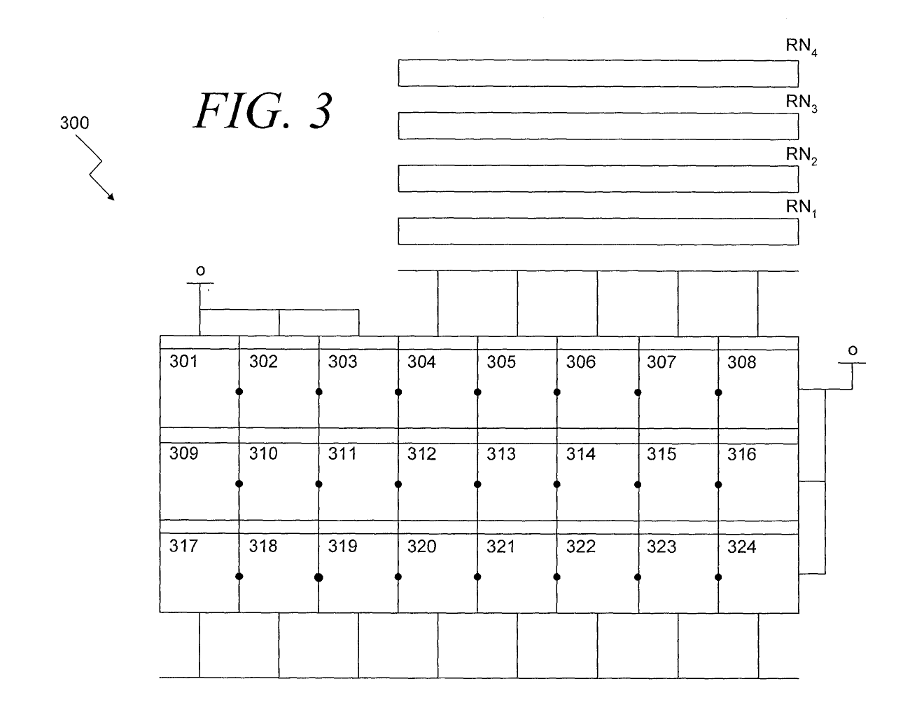

With reference now to FIG. 1 of the Drawings, there is illustrated therein a schematic drawing of a single cell of a cellular array described further hereinafter in connection with FIG. 3, utilizing the principles of the present invention. As illustrated in FIG. 1, a cell unit, generally designated by the reference numeral 100, includes a variety of components.

For example, the cell unit 100 has a full adder 110 and a single-bit storage register 120. As shown in the figure, an incoming bit (i) feeds into both the full adder 110 and the storage register 120, which stores the incoming bit therein for one clock cycle until the next input replaces it. It should, of course, be understood that the register 120 acts as a time delay, whereby the incoming bit i is added in adder 110 with the previous incoming bit stored in the storage register 120. Another input to the full adder 110 is a carry-in bit (c₁), which initially is zero. As is understood in the art, the carry-in bit input to the full adder 110 is dependent upon a variable sum described in more detail hereinbelow in connection with the carry-out bit (cₒ). The addition of the three inputs, i.e., i, previous i and cᵢ, in the full adder 110 generates a sum or output (o) along with the aforementioned carry-out bit cₒ. It should be understood that the carry-in and carry-out bits cᵢ and cₒ may be either zero or one and are dependent upon the summation inputs. For example, if i and c₁ are one and the register 120 contains a zero, then o is zero and cₒ is one. However, if i is one and cᵢ and the register 120 contain zero, then o is one and cₒ is zero.

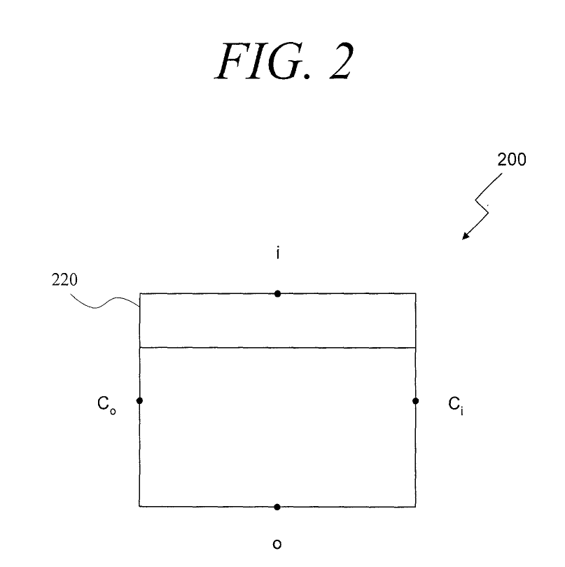

With reference now to FIG. 2, there is illustrated a symbol representation for the cell unit 100 illustrated and described in connection with FIG. 1 hereinabove. The representation or block diagram of the cell unit designated in FIG. 2 by the reference number 200 includes the various inputs and outputs described above, e.g., input i, carry-in c₁, carry-out cₒ, and output o. Also generally designated is the storage register 120 of FIG. 1, having a reference numeral 220 in FIG. 2. It should, of course, be understood that the logical operation of the symbolic cell unit 200 is identical to that of cell unit 100 in FIG. 1.

With reference now to FIG. 3, there is illustrated a cellular array, generally designated by the reference numeral 300, and including a number of cell units whose logical operation is described hereinabove in connection with FIG. 1 and whose symbolic representation is described hereinabove in connection with FIG. 2. The operation of the cellular array 300 is described hereinbelow following the path of several random numbers of random uniform distribution RN₁, RN₂, RN₃ and RN₄, through the array.

A random number RN₁, in this case of bit-width 5, is fed into as input bits i of cells 304, 305, 306, 307 and 308 within cellular array 300. As also shown in FIG. 3, a value zero is fed into cᵢ of edge cells 308, 316 and 324 to initialize the array, and a value zero is fed into i of initial input cells 301, 302 and 303. In this manner the eight input cells 301, 302, 303, 304, 305, 306, 307 and 308 are initialized.

A second random number RN₂ is then fed into i of cells 304, 305, 306, 307 and 308. It should be understood that this number is added to the previous random number RN₁ due to the time delay from the storage register 120 of FIG. 1. The sum of the two numbers, including a carry-out bit cₒ, is passed to the second row of the array of cells 311, 312, 313, 314, 315 and 316.

A third random number RN₃ is then fed into i of cells 304, 305, 306, 307 and 308. This number RN₃, after being added to the second random number RN₂ already stored in the storage register 120 of FIG. 1 and passed to the second row of the array of cells 311, 312, 313, 314, 315 and 316, is added to the sum of the first and second random numbers RN₁, RN₂ stored in cells 311, 312, 313, 314, 315 and 316 as stored in the storage register 120 of FIG. 1. The result, a sum of the first and second random numbers RN₁, RN₂ and the second and third random numbers RN₂, RN₃, is passed on, including a carry-out bit cₒ, to the third row of cells 318, 319, 320, 321, 322, 323 and 324.

A fourth random number RN₄ is then fed into the inputs i of the first row of cells 304, 305, 306, 307 and 308. This number RN₄ is added to the third random number RN₃, stored in the time delay register 120 of FIG. 1, in the first row of cells, and then added to the sum of the second and third random numbers RN₂, RN₃, stored in the time delay register 120 of FIG. 1, in the second row of cells, then passed on to the third row of the array of cells 318, 319, 320, 321, 322, 323 and 324. Finally, the sum is added to the sum already stored in the third row, of the first and second random numbers RN₁, RN₂ and the second and third random numbers RN₂, RN₃, and passed, including a carry-out bit cₒ, out of the array through the outputs o of cells 317, 318, 319, 320, 321, 322, 323 and 324.

The amount of input numbers will have an effect on the output distribution of the cellular array illustrated in FIG. 3. Statistically, a larger sample size will produce a more accurate distribution of random numbers, as is known in the art.

The cellular array shown in FIG. 3 receives input random numbers of bit-length five and produces output numbers of bit-width eight, and contains three stages. In general, a cellular array may receive input numbers of any bit-length. The array will then produce output numbers in a range that is a multiple of the range of the input numbers. For example, when the array is constructed with only one stage, the range of the output numbers is twice that of the input numbers, and when the array is constructed with two stages, the range of the output numbers is three times that of the input numbers, and so on. Therefore, when the desired range of the output numbers and the number of stages used is known, then the range or bit-length of the input numbers can be chosen using that information.

The number of stages affects the resolution of the output as well as the range. Each stage increases the resolution of the output distribution by adding one bit of resolution to each outputted number.

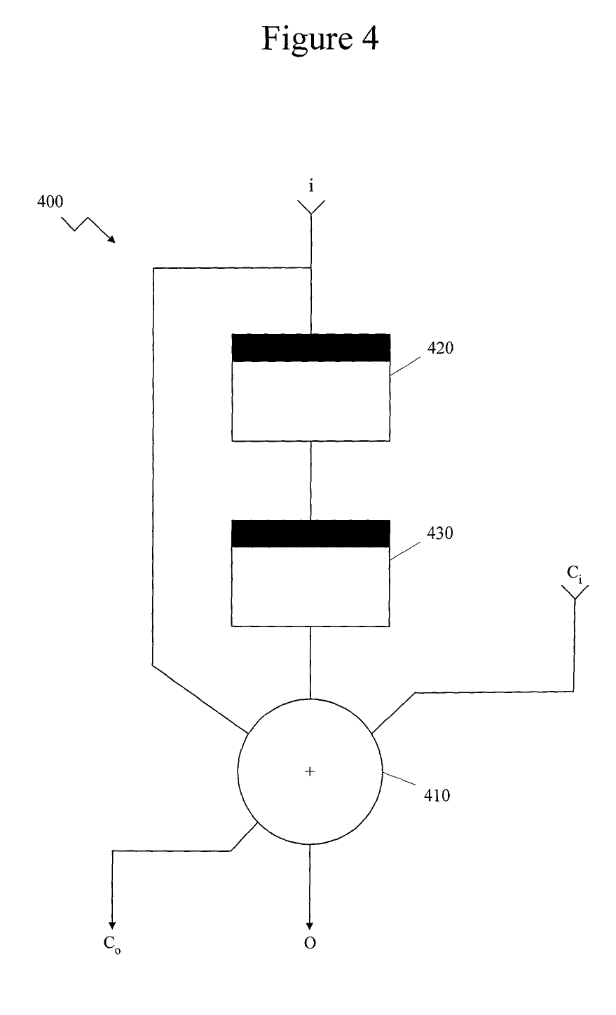

With reference now to FIG. 4 of the Drawings, there is illustrated a cell of an alternate embodiment of the present invention, generally designated by the reference numeral 400. Similar to the cell 100 described in reference to FIG. 1, the cell 400 includes a full adder 410 and two single-bit storage registers 420 and 430. As shown in the figure, an incoming bit (i) feeds into both the full adder 410 and the storage register 420, which stores the incoming bit therein for one clock cycle until the next input replaces it. In the next clock cycle, the incoming bit i moves to the next storage register 430, which then stores the bit for a second clock cycle, until it is replaced. It should, of course, be understood that the registers 420 and 430 act as time delays, whereby the incoming bit i is added in adder 410 with the twice-delayed incoming bit stored in the storage register 430. As compared with the cell 100 of FIG. 1, the cell 400 has a greater de-correlation between the incoming bit i and the bit stored in 430 that is added to i in the adder 410. As in the cell 100 of FIG. 1, another input to the full adder 410 is a carry-in bit (cᵢ), which initially is zero. As described hereinabove in connection with FIG. 1, the carry-in bit input to the full adder 410 is dependent upon a variable sum of i, previous i and cᵢ, in the full adder 410, the sum or output (o) generated along with a carry-out bit cₒ. It should be understood that the carry-in and carry-out bits, cᵢ and cₒ, may be either zero or one and are dependent upon the summation inputs. For example, if i and cᵢ are one and the register 430 contains a zero, then o is zero and cₒ is one. However, if i is one and cᵢ and the register 430 contain zero, then o is one and cₒ is zero.

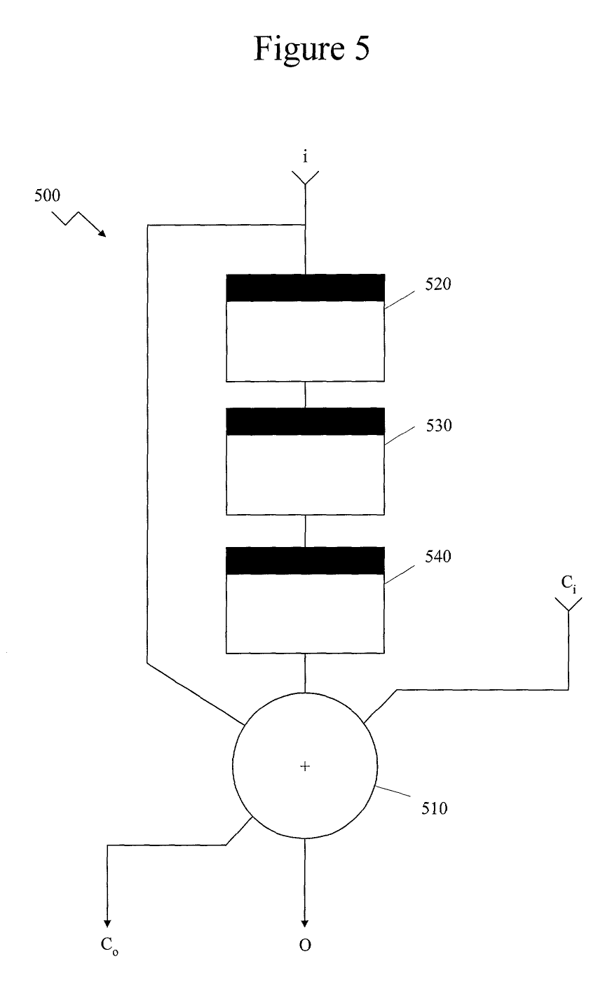

With reference now to FIG. 5, there is illustrated a cell of another alternate embodiment of the present invention, generally designated by the reference numeral 500. Similar to the cell 400 described hereinabove, cell 500 includes a full adder 510 and several time delay storage registers 520, 530, and 540. With one more storage register 540 than the cell 400 of FIG. 4, though, cell 500 includes an even greater de-correlation between the incoming bit i and the stored bit of register 540 added in the adder 510.

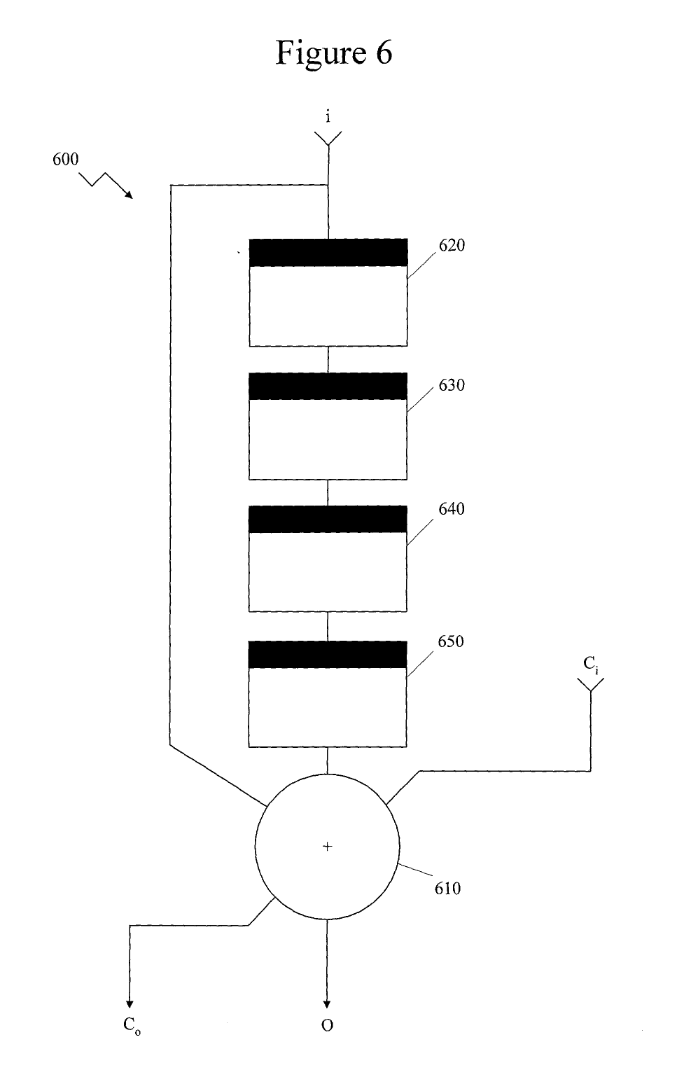

With reference now to FIG. 6, there is illustrated a cell of yet another alternate embodiment of the present invention, generally designated by the reference numeral 600. Similar to the cells 400 and 500 described hereinabove, cell 600 includes a full adder 610 and many time delay storage registers 620, 630, 640, and 650. With one more storage register 650 than the cell 500 of FIG. 5, though, cell 600 includes the greatest de-correlation between the incoming bit i and the stored bit of register 640 added in the adder 610 of the examples thus far.

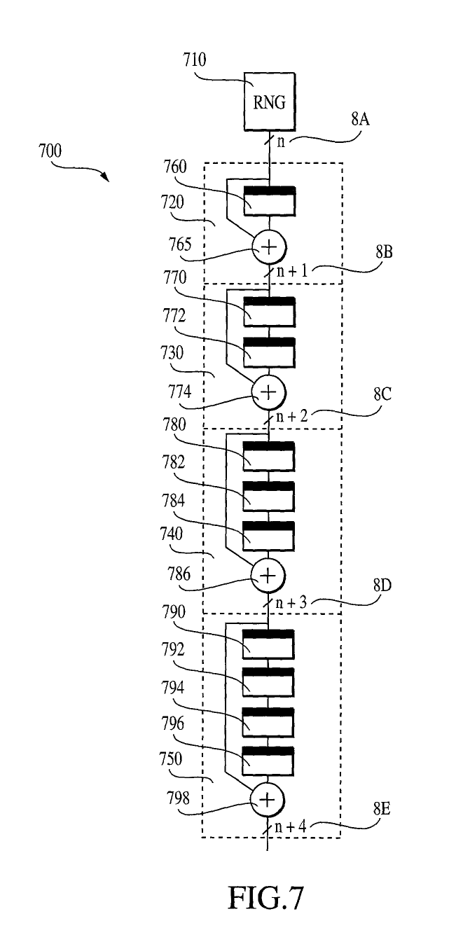

With reference now to FIG. 7, there is illustrated a cellular array of an alternate embodiment of the present invention, generally designated by the reference numeral 700. Pictured in FIG. 7 are a random number generator 710, and cells from each row of the array of the various embodiments set forth above, i.e., a cell of stage one 720, a cell of stage two 730, a cell of stage three 740, and a cell of stage four 750. The cell of stage one 720 is the cell 100 described in connection with FIG. 1, containing one register 760 therein that acts as a time delay and an adder 765, while each successive stages or cells 730, 740, and 750 contains an increasing number of registers, e.g., cell 730 contains two registers 770 and 772 and an adder 774; cell 740 contains three registers 780, 782, and 784 and an adder 786; and cell 750 contains four registers 790, 792, 794, and 796 and an adder 798. The increasing number of registers that act as time delays greatly increases the de-correlation between the stages. It should be apparent that the cell 730 of stage two is cell 400 described in connection with FIG. 4, cell 740 of stage three is cell 500 described in connection with FIG. 5, and cell 750 of stage four is cell 600 described in connection with FIG. 6. The alternate embodiment of FIG. 7 operates in substantially the same manner as the embodiment of FIG. 3, with an increase in de-correlation and time delay caused by the added registers in the cells of stages two, three, and four 730, 740, and 750.

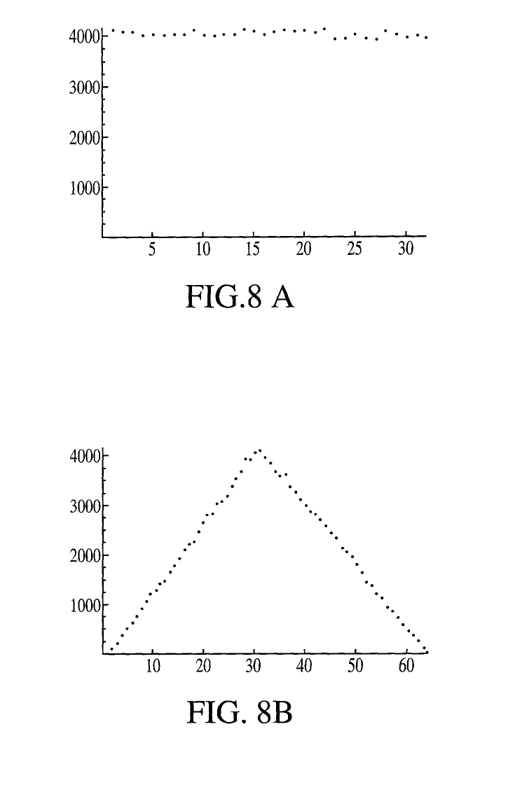

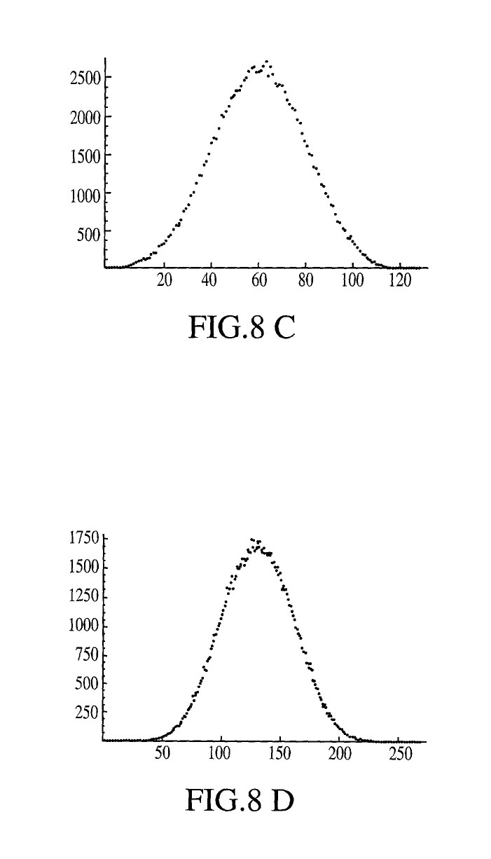

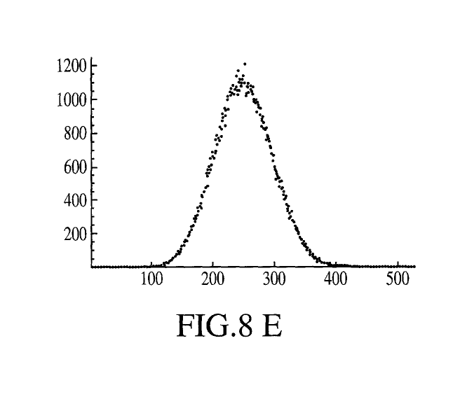

With reference now to FIGS. 8A-8E, there are illustrated therein several graphs of the input and output of the cellular array 700 described hereinabove in connection with FIG. 7. The histogram graphs illustrate a trend of converting the input random number stream of FIG. 8A to a number stream of approximately Gaussian distribution in FIG. 8E, and also illustrate the effect of the cellular array 700 on the range of the number stream in the x-axis, as well as in the y-axis, and the frequency of occurrence for each value of the number stream in the x-axis.

With reference now to FIG. 8A, there is illustrated a data stream that may be used as input to the cellular array as described in reference to FIG. 7. The data stream is made up of 5-bit random numbers with a range of [0 . . . 31] in a substantially uniform distribution. In the graph of the data stream, the range of numbers is indicated in the x-axis, and the uniformity of occurrence is indicated in the y-axis.

With reference to FIG. 8B, there is illustrated the data steam of FIG. 8A after the data stream has passed through stage one of the cellular array of FIG. 7. The immediate effect of the first stage of the cellular array can be clearly seen in FIG. 8B. The data stream has a triangular distribution and covers an expanded range of [0 . . . 62], as shown in the x-axis, with the greatest of occurrence of numbers around 31 and decreasing occurrence of numbers greater and less than 31. Also, the data stream is formed of 6-bit random numbers that are the sum of two 5-bit random numbers.

With reference now to FIG. 8C, the data stream of FIG. 8A is further transformed after having passed through stage one and two of the cellular array 700. The second stage has an effect shown in the increasingly Gaussian-like distribution of the data stream. Also shown in the graph of the data stream is the expanded range of [0 . . . 124] indicated by the x-axis, and the decreased occurrence of numbers around 62 as well as numbers greater and less than 62, caused by a static amount of numbers in an expanded range.

With reference to now FIG. 8D, the data stream of FIG. 8A is further transformed after having passed through stages one, two, and three of the cellular array 700. The third stage has an effect shown in the increasingly Gaussian-like distribution of the data stream. Also shown in the graph of the data stream is the expanded range of [0 . . . 248] indicated by the x-axis, and the decreased occurrence of numbers around 124 as well as numbers greater and less than 124, caused by a static amount of numbers in an expanded range.

With reference to now FIG. 8E, the data stream of FIG. 8A is finally transformed after having passed through stages one, two, three, and four of the cellular array 700 of FIG. 7. The fourth stage has an effect shown in the Gaussian-like distribution of the data stream. Also shown in the graph of the data stream is the expanded range of [0 . . . 496] indicated by the x-axis, and the decreased occurrence of numbers around 248 as well as numbers greater and less than 248, caused by a static amount of numbers in an expanded range.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

What is claimed is:

1. A cellular array for converting a sequence of substantially uniform distribution random numbers to a sequence of substantially Gaussian distribution random numbers, said cellular array comprising:
a plurality of cells connected sequentially along a first dimension of said cellular array, each cell containing therein an adder and a sequentially-increasing number of time delay registers, each cell receiving the resultant sum of the preceding cell as input and outputting the sum of the resultant sum of the preceding cell with the respective time-delayed resultant sum of a prior cell; and
a plurality of cells connected sequentially along a second dimension of said cellular array, each cell containing a carry-in and a carry-out in communication with cells adjacent along said second dimension of said cellular array, each said carry-in being an input to the adder of a respective cell and each said carry-out being an output from the adder of the respective cell.

2. The array according to claim 1, wherein the first of said plurality of cells connected sequentially along a first dimension of said cellular array receives as in put said substantially uniform distribution random numbers, and the last of said plurality of cells connected sequentially along a first dimension of said cellular array transmits as output said substantially Gaussian distribution random numbers.

3. The array according to claim 1, wherein said plurality of cells connected sequentially along said second dimension of said cellular array forms a plurality of stages.

4. The array according to claim 3, wherein the number of cells connected sequentially along said first dimension of said cellular array is the number of stages and the bit-width of each random number of the sequence of substantially uniform distribution random numbers.

5. The array according to claim 1, wherein said cellular array is implemented in an integrated circuit.

6. A cellular array for converting a sequence of substantially uniform distribution random numbers to a sequence of substantially Gaussian distribution random numbers, said cellular array comprising:
a first cell containing a time delay register and an adder therein, an input from said sequence of substantially uniform distribution random numbers being fed into said time delay register and adder, said adder outputting a resultant sum of said input from said time delay register and a next input from said sequence of substantially uniform distribution random numbers; and
a second cell containing a first time delay register, a second time delay register and another adder, the resultant sum of the first cell being fed into said first time delay register and said another adder, said first time delay register delaying receipt of said resultant sum into said second time delay register which time delays said resultant sum into said another adder, a second resultant sum being formed by said another adder adding the resultant sum from said first cell time delayed through said first and second time delay registers with a subsequent resultant sum from said first cell.

7. The cellular array according to claim 6, said cellular array further comprising:
a third cell containing a third, fourth and a fifth time delay register and a third adder, the second resultant sym of the second cell being fed into said third time delay register and said third adder, said third, fourth and fifth time delay registers each sequentially delaying receipt of said second resultant sum into said third adder, a third resultant sum being formed by said third adder adding the second resultant sum from the second cell time delayed through said third, fourth and fifth time delay registers with another second resultant sum from said second cell.

8. The cellular array according to claim 7, said cellular array further comprising:
a fourth cell containing a sixth, seventh, eighth and ninth time delay register and a fourth adder, the third resultant sum of the third cell being fed into said sixth time delay register and said fourth adder, said sixth, seventh, eighth and ninth time delay registers each sequentially delaying receipt of said third resultant sum into said fourth adder, a fourth resultant sum being formed by said fourth adder adding the third resultant sum from the third cell time delayed through said sixth, seventh, eighth and ninth time delay registers with another third resultant sym from said third cell.

9. The array according to claim 6, wherein said cellular array is implemented in an integrated circuit.

10. The array according to claim 8, wherein said first cell, said second cell, said third cell and said fourth cell are arranged in a column, and wherein said column is repeated a plurality of times.

11. The array according to claim 10, wherein in said array, said column is repeated at least the number of the bit-width of each random number of the sequence of substantially uniform distribution random numbers, and said fourth cell is repeated at least the number of the bit-width of each random number of the sequence of substantially Gaussian distribution random numbers.

12. A method for converting a sequence of substantially uniform distribution random numbers across a first range to a sequence of substantially Gaussian distribution random numbers across a second range, said sequence of substantially uniform distribution random numbers being divided into a plurality of sequential numbers within said first range, said method comprising the steps of:
adding a first of said plurality of sequential numbers to the next of said plurality of sequential numbers, forming a resultant sum thereof, said resultant sum having a corresponding preceding sum associated therewith, said preceding sum being the sum of said first of said plurality of sequential numbers and the number preceding said first of said plurality of sequential numbers; and
adding said resultant sum of said sequential numbers to said preceding sum, forming a second resultant sum thereof.

13. The method according to claim 12, said method repeating for each of said plurality of sequential number pairs forming respective resultant sums thereof.
